(19) United States
(12) Patent Application Publication
(10) Pub. No.: US 2026/0095966 A1
(43) Pub. Date: Apr. 2, 2026

(54) SYSTEMS AND METHODS FOR CONFIGURING UNMANNED AERIAL VEHICLE (UAV) MULTI-RAT DUAL CONNECTIVITY (MRDC)

(71) Applicant: ZTE Corporation, Shenzhen, Guangdong (CN)

(72) Inventors: Yansheng LIU, Shenzhen (CN); Yin GAO, Shenzhen (CN); Dapeng LI, Shenzhen (CN); Jiren HAN, Shenzhen (CN)

(73) Assignee: ZTE Corporation, Shenzhen, Guangdong (CN)

(21) Appl. No.: 18/749,103

(22) Filed: Jun. 20, 2024

Related U.S. Application Data
(63) Continuation of application No. PCT/CN2022/110688, filed on Aug. 5, 2022.

(51) Int. Cl. H04W 76/15

(52) U.S. Cl. CPC H04W 76/15

(57) ABSTRACT

Presented are systems and methods for configuring unmanned aerial vehicle (UAV) multi-RAT dual connectivity (MRDC). A first wireless communication node may communicate with a second wireless communication node to share one or more configuration containers. The one or more configuration containers may include various information associated with a terminal service and wherein the one or more configuration containers correspond to different radio access technologies (RATs).

### CROSS-REFERENCE TO RELATED APPLICATION

This application claims the benefit of priority under 35 U.S. C. § 120 as a continuation of International Patent Application No. PCT/CN2022/110688, filed on Aug. 5, 2022, the disclosure of which is incorporated herein by reference in its entirety.

### TECHNICAL FIELD

The disclosure relates generally to wireless communications, including but not limited to systems and methods for configuring unmanned aerial vehicle (UAV) multi-RAT dual connectivity (MRDC).

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A first wireless communication node (e.g., a master node (MN)) may communicate with a second wireless communication node (e.g., a secondary node (SN)) to share one or more configuration containers. The one or more configuration containers may include various information associated with a terminal service and wherein the one or more configuration containers correspond to different radio access technologies (RATs). The one or more configuration containers may include at least one of a Long-Term Evolution (LTE) configuration container or a New Radio (NR) configuration container.

In some embodiments, the various information may include at least one of: wireless communication device (e.g., Unmanned Aerial Vehicle (UAV)) identification configured to identify a wireless communication device; wireless communication device service subscription information configured to notify the wireless communication node that the wireless communication device is qualified to use wireless communication device service; one or more report receiver's addresses to which wireless communication device's data is to be collected; wireless communication device location information configuring wireless communication device location measurement and reporting; height reporting information associated with the wireless communication device; flight path information associated with the wireless communication device; or measurement information including frequency-related information of the wireless communication device.

In some embodiments, the first wireless communication node may receive a first message including the one or more configuration containers from a core network. The first wireless communication node may send a second message including the one or more configuration containers to a wireless communication device (e.g., a UE). The first message can be a first communication message. The second message can be a second communication message.

In some embodiments, the first wireless communication node may receive a first message including the one or more configuration containers from a core network. The first wireless communication node may send a second message including the one or more configuration containers to the second wireless communication node. The first message can be a first communication message. The second message can be a third communication message. The one or more configuration containers can be further sent to a wireless communication device through a first communication message.

In some embodiments, at least some of the various information can be reported by a wireless communication device to a core network through the first wireless communication node, to the core network through the second wireless communication node, to the core network first through the second wireless communication node then through the first wireless communication node, or to the core network first through the first wireless communication node then through the second wireless communication node.

In some embodiments, the first wireless communication node may send a first message requesting to change the second wireless communication node to the third wireless communication node to a third wireless communication node (e.g., a target node). The first message may include the one or more configuration containers. The first message can be a third communication message.

In some embodiment, the first wireless communication node may receive a first message requesting to change the second wireless communication node to a third wireless communication node from the second wireless communication node. The first wireless communication node may send a second message including the one or more configuration containers to the third wireless communication node. The first message and second message can be each a third communication message.

In some embodiments, the first wireless communication node (e.g., a source MN) may send a first message indicating a handover from the first wireless communication node to the fourth wireless communication node to a fourth wireless communication node (e.g., a target MN). The first message can be an Xn Application Protocol (XnAP) message, and may include the one or more configuration containers. The one or more configuration containers, included in the first message, can be further sent from the fourth wireless communication node to the second wireless communication node through another third communication message.

In some embodiments, the first wireless communication node may send a first message requesting to add the second wireless communication node to the second wireless communication node. The first message can be a third communication message, and may include the one or more configuration containers.

In some embodiments, the first wireless communication node may send a first message requesting to remove the second wireless communication node to the second wireless communication node. The first wireless communication node may receive a second message including the one or more configuration containers from the second wireless communication node. The first message and second message can be each a third communication message.

In some embodiments, the first wireless communication node may receive a first message requesting to remove the second wireless communication node itself from the second wireless communication node. The first message can be a third communication message and may include the one or more configuration containers. In certain embodiments, the first communication message can be an NG Application Protocol (NGAP) message. The second communication message can be a Radio Resource Control (RRC) message. The second communication message can be an Xn Application Protocol (XnAP) message.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a sequence diagram for secondary node (SN) addition procedure, in accordance with some embodiments of the present disclosure;

FIG. 4 illustrates a sequence diagram for secondary node (SN) modification procedure, in accordance with some embodiments of the present disclosure;

FIG. 5 illustrates a sequence diagram for secondary node (SN) change procedure, in accordance with some embodiments of the present disclosure;

FIG. 6 illustrates a sequence diagram for inter-master node (MN) handover procedure, in accordance with some embodiments of the present disclosure;

FIG. 7 illustrates a sequence diagram for unmanned aerial vehicle (UAV) configuration over master node (MN), in accordance with some embodiments of the present disclosure;

FIG. 8 illustrates a sequence diagram for unmanned aerial vehicle (UAV) configuration over secondary node (SN), in accordance with some embodiments of the present disclosure;

FIG. 9 illustrates a sequence diagram for unmanned aerial vehicle (UAV) reporting in dual connectivity (DC), in accordance with some embodiments of the present disclosure;

FIG. 10 illustrates a sequence diagram for mobility in master node (MN) initiated secondary node (SN) change, in accordance with some embodiments of the present disclosure;

FIG. 11 illustrates a sequence diagram for mobility in secondary node (SN) initiated secondary node (SN) change, in accordance with some embodiments of the present disclosure;

FIG. 12 illustrates a sequence diagram for inter-master node (MN) handover with/without SN change, in accordance with some embodiments of the present disclosure;

FIG. 13 illustrates a sequence diagram from standalone architecture to dual connectivity architecture, in accordance with some embodiments of the present disclosure;

FIG. 14 illustrates a sequence diagram from dual connectivity architecture to standalone architecture, in accordance with some embodiments of the present disclosure; and

FIG. 15 illustrates a flow diagram for configuring unmanned aerial vehicle (UAV) multi-rat dual connectivity (MRDC), in accordance with an embodiment of the present disclosure.

### DETAILED DESCRIPTION

### 1. Mobile Communication Technology and Environment

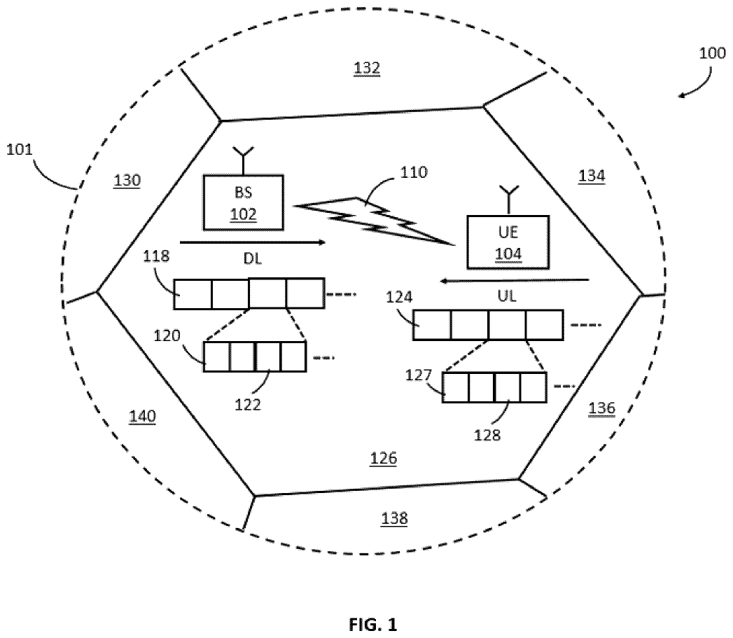

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

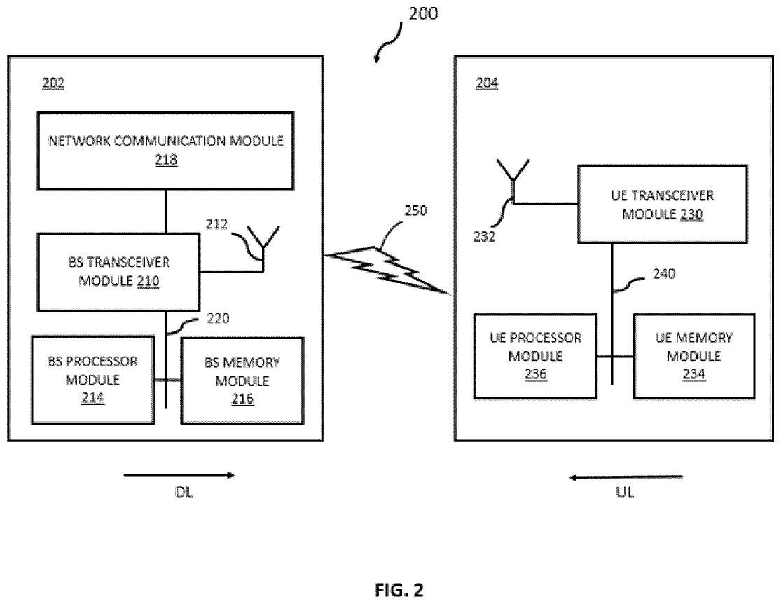

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Configuring Unmanned Aerial Vehicle (UAV) Multi-RAT Dual Connectivity (MRDC)

Unmanned aerial vehicle (UAV) related features may be supported in Rel-18 new radio (NR) specifications. In some cases, the UAV related features may not be supported in NR. By using procedures introduced in this invention, UAV configuration(s) and report(s) can be transmitted between network (NW) and user equipment (UE) and/or between master node (MN) and secondary node (SN).

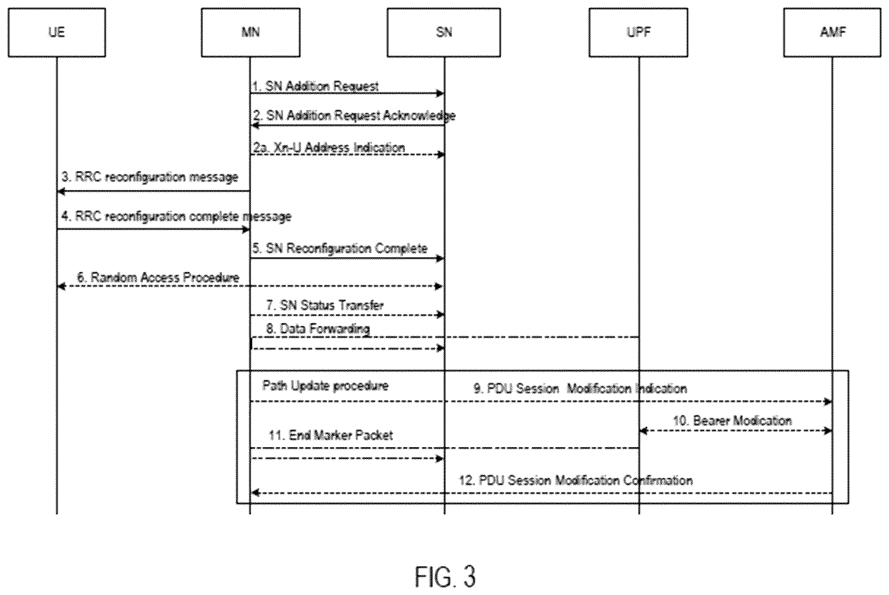

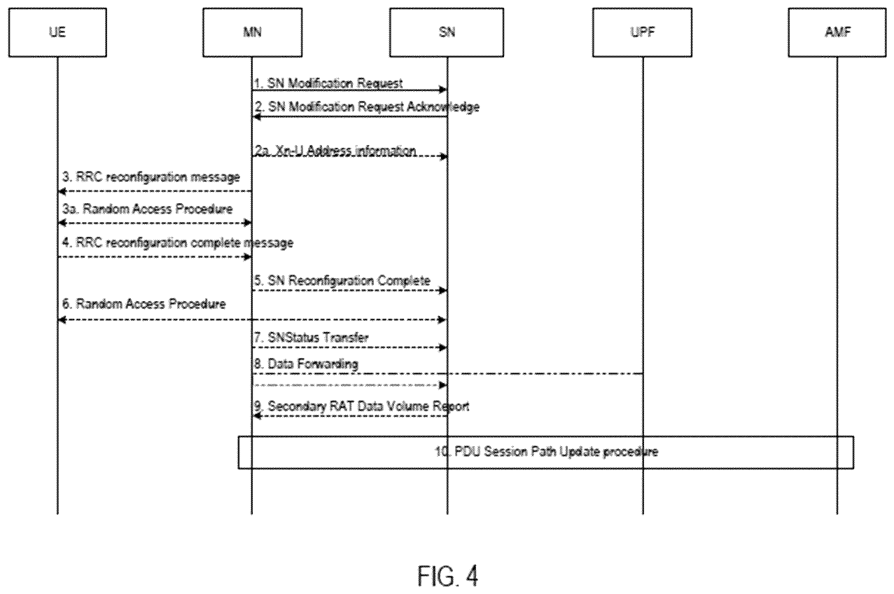

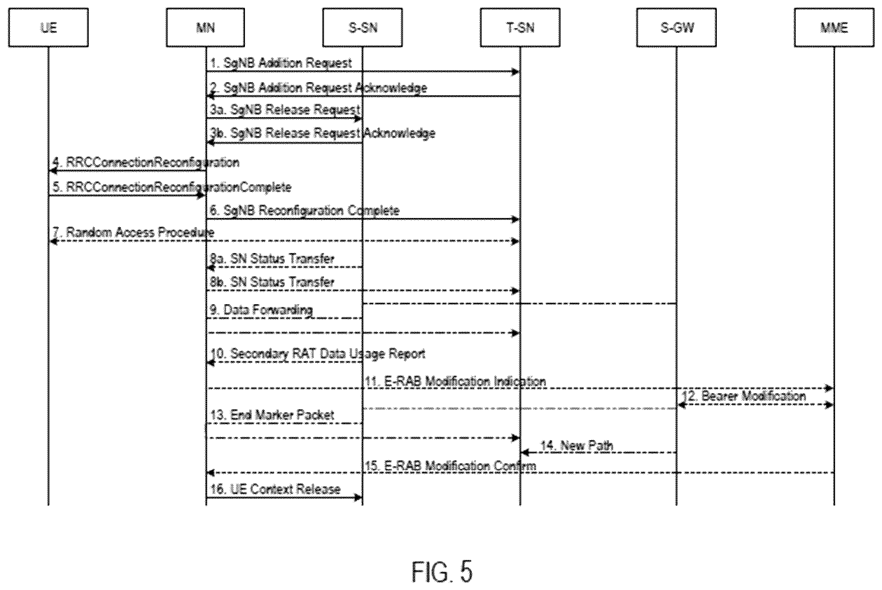

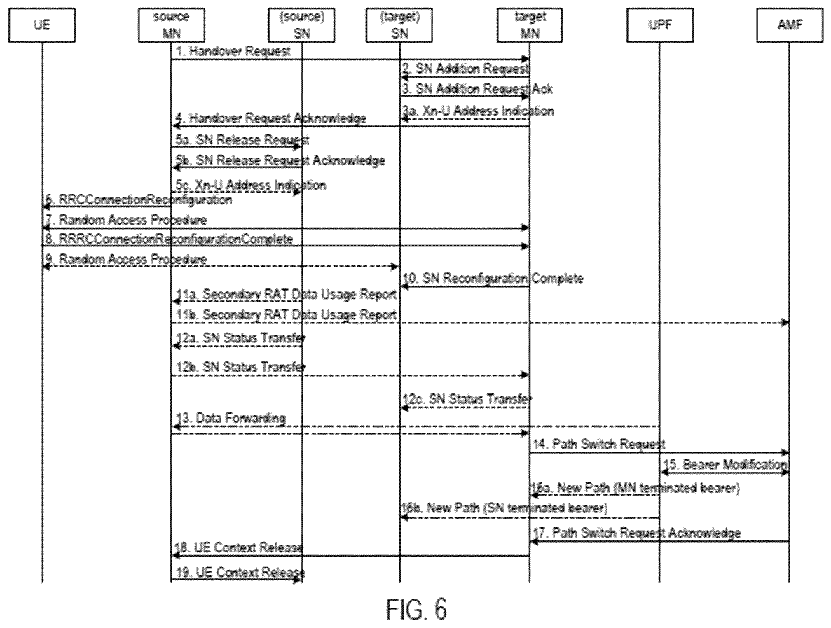

FIGS. 3-6 illustrate call flows for multi-radio access technology (RAT) dual connectivity (MRDC) related procedures (e.g., SN addition, SN modification, and/or SN change). FIG. 3 is a call flow for SN addition procedure. FIG. 4 is a call flow for SN modification procedure (MN initiated). FIG. 5 is a call flow for SN change procedure (MN initiated). FIG. 6 is a call flow for inter-MN handover with/without MN initiated SN change procedure. In some embodiments, a NG Application Protocol (NGAP) message, an Xn Application Protocol (XnAP) message, and/or a Radio Resource Control (RRC) message can be implemented as any of various other messages.

### Implementation Example 1: UAV Configuration Containers (for Inter-RAT Mobility)

This implementation example explains reasons on why UAV configuration containers may be introduced for an inter-RAT handover. For a heterogeneous network, an inter-system handover (HO) (e.g., HO between gNB and eNB with changing of core network (CN) between access and mobility management function (AMF) and mobility management entity (MME)) and intra-system inter-radio access technology (RAT) (e.g., HO between gNB and ng-eNB. The CN may be AMF) handover may be performed during a UE mobility. To maximally maintain a UAV service continuity, a same UAV related configuration with different encoding/format for both NR and LTE may be configured to a RAN node in a different container. The UE may keep using a UAV related function no matter different RATs used between RAN nodes during the HO. The UAV configuration containers may be configured to the UE before the HO or during the HO.

In some embodiments, at least one of the following information may be added into both NR and LTE containers: a UAV identification (ID), UAV subscription information, report receiver's address(es), a UAV location configuration, a height reporting configuration, a flight path information configuration, or a measurement configuration. The UAV ID can be used/configured to identify a UAV. The UAV subscription information can include a flag which is used/configured to notify a RAN node that a UE is qualified to use the UAV service. The report receiver's address can include an IP address or URL for the UAV data collector. Different UAV data types may have the same destination or different destinations. The UAV location configuration can include information about UAV location measurement and reporting (e.g., an accurate requirement of the UAV location), what kinds of positioning methods may be used, a measurement/reporting frequency, and/or an integrity requirement. The height reporting configuration can include criteria on when the UE may report its height, measurement/reporting frequency, accuracy of the height measurement, and/or integrity requirement. The flight path information configuration can include a UE flight path history or prediction, a formula, a flight path (e.g., a list of cell ID, RAN node ID, coordinates), a number of points in the flight path list, a timestamp requirement, an accuracy requirement, an integrity requirement, and/or a reporting destination (e.g., IP or URL). The measurement configuration can include UE frequency-related measurement information (e.g., reference signal received power (RSRP), reference signal received quality (RSRQ), signal-to-noise and interference ratio (SINR) of cells).

### Implementation Example 2: UAV Configuration Over MN

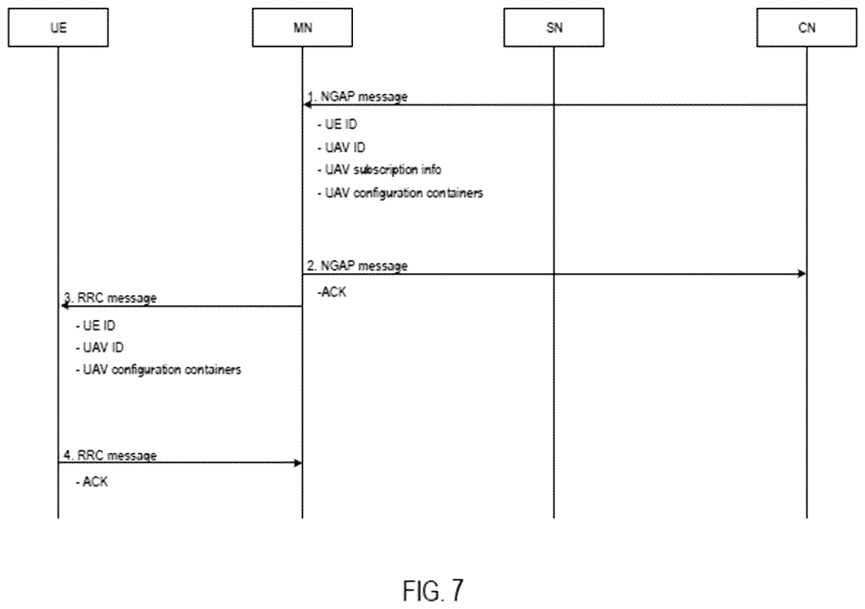

FIG. 7 is a call flow for UAV configuration over MN procedure.

In step 1, a CN may send a NGAP message to a MN for UAV configuration(s). At least one of the following information can be contained/included in the NGAP message: UE identification information (e.g., UE ID), UAV identification information (e.g., UAV ID), UAV subscription information, or UAV configuration containers. The UAV subscription information can include a flag which is used/configured to notify a RAN node that a UE is qualified to use the UAV service. The UAV configuration containers may include LTE configuration container(s) and/or NR configuration container(s).

In step 2, the MN may send a reply NGAP message to the CN with ACK information.

In step 3, the MN may send the received UAV configuration information to a UE via a radio resource control (RRC) message. At least one of the following information can be contained in the RRC message: UE identification information (e.g., UE ID), UAV identification information (e.g., UAV ID), UAV subscription information, or UAV configuration containers. The UAV subscription information can include a flag which is used/configured to notify a RAN node that a UE is qualified to use the UAV service. The UAV configuration containers may include LTE configuration container(s) and/or NR configuration container(s).

In step 4, the UE may send a reply RRC message to the MN with ACK information.

In some embodiments, a NGAP message and/or a RRC message can be implemented as any of various other messages.

### Implementation Example 3: UAV Configuration Over SN

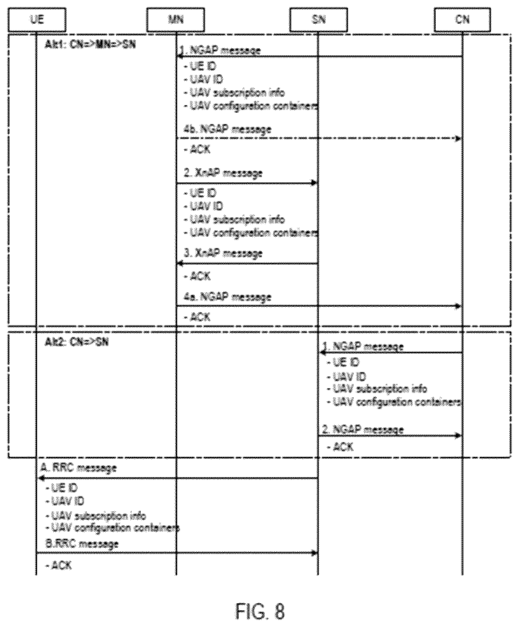

FIG. 8 is a call flow for UAV configuration over SN procedure. Two alternatives are introduced in this implementation example. A SN may receive UAV configuration via either a MN or a CN.

### Alternative 1: a MN Transfers Received UAV Configuration to a SN

In step 1, a CN may send a NGAP message to a MN with UAV configuration information. At least one of the following information can be contained in the NGAP message: UE identification information (e.g., UE ID), UAV identification information (e.g., UAV ID), UAV subscription information, or UAV configuration containers. The UAV subscription information can include a flag which is used/configured to notify a RAN node that a UE is qualified to use the UAV service. The UAV configuration containers may include LTE configuration container(s) and/or NR configuration container(s).

In step 2, the MN may send the received UAV configuration information to a SN via an XnAP message. At least one of the following information can be contained in the XnAP message: UE identification information (e.g., UE ID), UAV identification information (e.g., UAV ID), UAV subscription information, or UAV configuration containers. The UAV subscription information can include a flag which is used/configured to notify a RAN node that a UE is qualified to use the UAV service. The UAV configuration containers may include LTE configuration container(s) and/or NR configuration container(s).

In step 3, the SN may send a reply XnAP message to the MN with ACK information.

In step 4a, the MN may send a reply NGAP message to the CN with ACK information.

In step 4b, the reply NGAP message may not be sent after the MN receives the reply XnAP message in step 3. The NGAP message may be forwarded from the MN to the CN before or when steps 2 and 3 XnAP procedure occur.

### Alternative 2: a CN Sends UAV Configuration to a SN

In step 1, a CN may send a NGAP message to a SN with UAV configuration information. At least one of the following information can be contained in the NGAP message: UE identification information (e.g., UE ID), UAV identification information (e.g., UAV ID), UAV subscription information, or UAV configuration containers. The UAV subscription information can include a flag which is used/configured to notify a RAN node that a UE is qualified to use the UAV service. The UAV configuration containers may include LTE configuration container(s) and/or NR configuration container(s).

In step 2, the SN may send a reply NGAP message to the CN.

In some embodiments, the NGAP message used in step 1 in different alternatives may be the same or different message. For either of alternatives, the UAV configuration may be finally sent to a UE by the following steps.

In step A, the SN may send a RRC message to a UE. At least one of the following information can be contained in the RRC message: UE identification information (e.g., UE ID), UAV identification information (e.g., UAV ID), UAV subscription information, or UAV configuration containers. The UAV subscription information can include a flag which is used/configured to notify a RAN node that a UE is qualified to use the UAV service. The UAV configuration containers may include LTE configuration container(s) and/or NR configuration container(s).

In step B, the UE may send a reply RRC message to the SN with ACK information.

### Implementation Example 4: UAV Reporting in Dual Connectivity (DC)

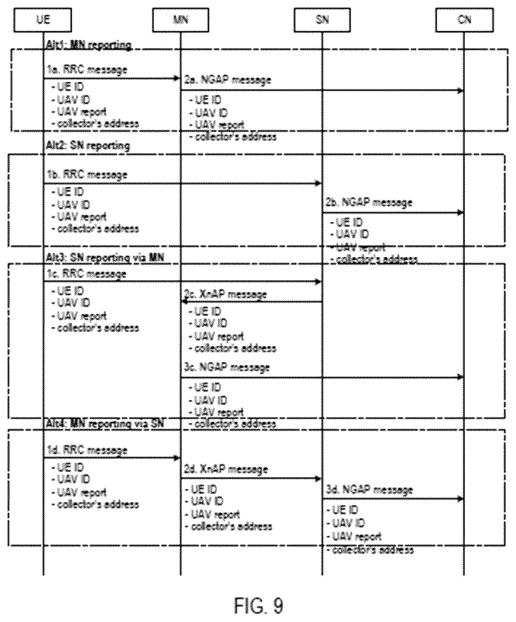

FIG. 9 is a call flow for UAV reporting procedure in dual connectivity (DC). At least one of the following information may be reported during the reporting procedure: UE identification information (e.g., UE ID), UAV identification information (e.g., UAV ID), a UAV report, or a collector's address. The UAV report may contain required UAV information. Detail can be checked in previous implementation example on the UAV configuration part. The collector's address can be either IP address or URL, which depends on what kinds of address has been configured.

As illustrated in FIG. 9, regardless of how does the UE receive the UAV configuration (via MN or SN), four alternatives may be used for UAV information reporting.

The RRC message, XnAP message, and NGAP message shown in FIG. 9 may be new introduced for UAV or enhanced by the existing messages. The XnAP message used in step 2c and step 2d may be same message or different messages.

### Implementation Example 5: Mobility in MN Initiated SN Change

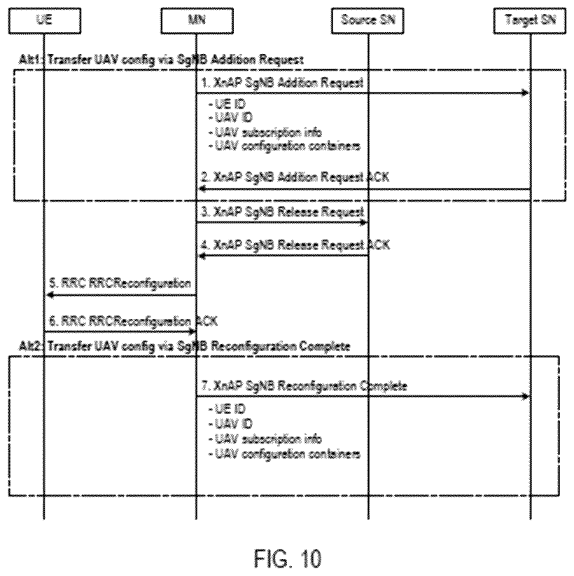

FIG. 10 is a call flow for mobility in a MN initiated SN change procedure. The procedures in the dotted line box are mandatory for this implementation example. The alternative part is which step can be used for UAV configuration transferring. The UAV configuration information can be transferred in either a SgNB addition Request message or a SgNB Reconfiguration Complete message. In some embodiments, it may be impossible for a MN to transfer UAV configuration information to a target SN via both these two XnAP messages.

In step 1, a MN may decide/determine to change a SN. The MN may send an XnAP message (e.g., SgNB Additional Request) to a target SN. At least one of the following information can be contained in the XnAP message: UE identification information (e.g., UE ID), UAV identification information (e.g., UAV ID), UAV subscription information, or UAV configuration containers. The UAV subscription information can include a flag which is used/configured to notify a RAN node that a UE is qualified to use the UAV service. The UAV configuration containers may include LTE configuration container(s) and/or NR configuration container(s).

In step 2, the target SN may send an XnAP message (e.g., SgNB Addition Request ACK) to the MN.

In steps 3 and 4, the MN may send an XnAP SgNB Release Request to a source SN, and the source SN may reply an XnAP SgNB Release Request ACK to the MN.

In steps 5 and 6, the MN may send a RRC RRCReconfiguration to a UE, and the UE may reply a RRC RRCReconfiguration ACK to the MN.

In step 7, the MN may send an XnAP message (e.g., SgNB Reconfiguration Complete) to the target SN. If the UAV configuration is not contained in step 1, the UAV configuration may be added into this XnAP message. At least one of the following information may be contained in the XnAP message: UE identification information (e.g., UE ID), UAV identification information (e.g., UAV ID), UAV subscription information, or UAV configuration containers. The UAV subscription information can include a flag which is used/configured to notify a RAN node that a UE is qualified to use the UAV service. The UAV configuration containers may include LTE configuration container(s) and/or NR configuration container(s).

### Implementation Example 6: Mobility in SN Initiated SN Change

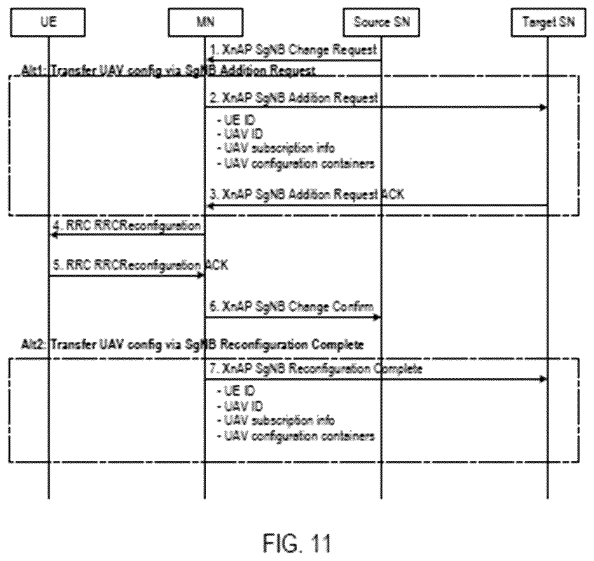

FIG. 11 is a call flow for mobility in a SN initiated SN change procedure. The procedures in the dotted line box are mandatory for this implementation example. The alternative part is which step can be used for UAV configuration transferring. The UAV configuration information can be transferred in either a SgNB addition Request message or a SgNB Reconfiguration Complete message. In some embodiments, it may be impossible for a MN to transfer UAV configuration information to a target SN via both these two XnAP messages.

In step 1, a source SN may decide to trigger a SN change procedure. The source SN may send an XnAP message (e.g., SgNB Change Request) to a MN.

In step 2, the MN may send an XnAP message (e.g., SgNB Additional Request) to a target SN. At least one of the following information can be contained in the XnAP message: UE identification information (e.g., UE ID), UAV identification information (e.g., UAV ID), UAV subscription information, or UAV configuration containers. The UAV subscription information can include a flag which is used/configured to notify a RAN node that a UE is qualified to use the UAV service. The UAV configuration containers may include LTE configuration container(s) and/or NR configuration container(s).

In step 3, the target SN may send an XnAP message (e.g., SgNB Addition Request ACK) to the MN.

In steps 4 and 5, the MN may send a RRC RRCReconfiguration to a UE, and the UE may reply a RRC RRCReconfiguration ACK to the MN.

In step 6, the MN may send an XnAP message (e.g. SgNB Change Confirm) to a source SN.

In step 7, the MN may send an XnAP message (e.g., SgNB Reconfiguration Complete) to the target SN. If the UAV configuration is not contained in step 1, the UAV configuration may be added into the XnAP message. At least one of the following information may be contained in the XnAP message: UE identification information (e.g., UE ID), UAV identification information (e.g., UAV ID), UAV subscription information, or UAV configuration containers. The UAV subscription information can include a flag which is used/configured to notify a RAN node that a UE is qualified to use the UAV service. The UAV configuration containers may include LTE configuration container(s) and/or NR configuration container(s).

### Implementation Example 7: Inter-MN Handover With/Without SN Change

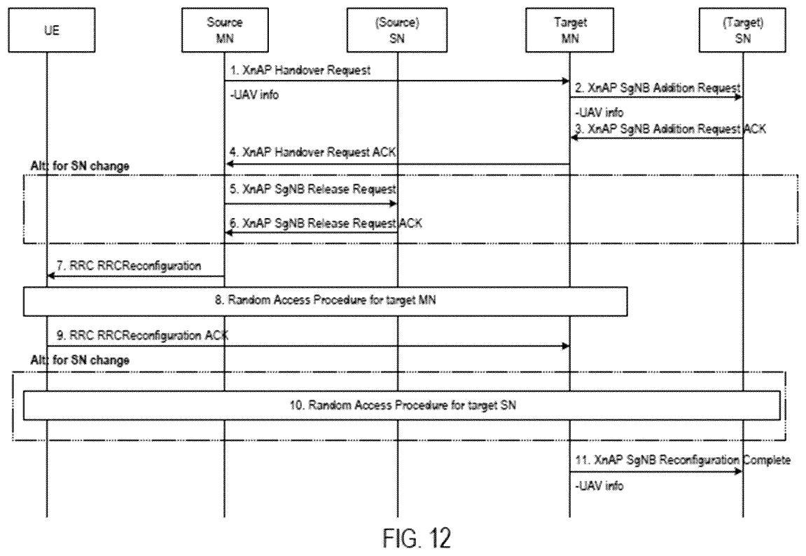

FIG. 12 is a call flow for inter-MN handover with/without SN change mobility.

For alternative a, the procedures inside the dotted line boxes are only for the SN change scenario. If a target MN decides to re-use the old SN, these procedures may not be needed anymore.

For alternative b, both procedures may be performed in this implementation example. How to send UAV information to a target SN may have different alternatives.

For inter-MN handover without SN change, a (source) SN and a (target) SN can be the same node since there is no SN change during handover. In such case, (source) SN==(target) SN==SN. For inter-MN handover with SN change, the (source) SN and (target) SN can be two different nodes.

In step 1, a source MN may trigger a handover procedure by sending a XnAP message (e.g., Handover Request) to a target MN. At least one of the following information can be contained in the XnAP message: UE identification information (e.g., UE ID), UAV identification information (e.g., UAV ID), UAV subscription information, or UAV configuration containers.

The UAV subscription information can include a flag which is used/configured to notify a RAN node that a UE is qualified to use the UAV service. The UAV configuration containers may include LTE configuration container(s) and/or NR configuration container(s).

In step 2, the target MN may send an XnAP message (e.g., SgNB Addition Request) to a SN (or target SN). At least one of the following information can be contained in the XnAP message: UE identification information (e.g., UE ID), UAV identification information (e.g., UAV ID), UAV subscription information, or UAV configuration containers. The UAV subscription information can include a flag which is used/configured to notify a RAN node that a UE is qualified to use the UAV service. The UAV configuration containers may include LTE configuration container(s) and/or NR configuration container(s).

In step 3, the SN (or target SN) may send a reply XnAP message (e.g. SgNB Addition Request ACK) to the target MN.

In step 4, the target MN may send an XnAP message (e.g. Handover Request ACK) to the source MN.

In steps 5 and 6 (conditional), the source MN may send an XnAP SgNB Release Request to a source SN, and the source SN may reply an XnAP SgNB Release Request ACK to the source MN.

In step 7, the source MN may send a RRC message (e.g., RRCReconfiguration) to a UE.

In step 8, the UE may initiate a random access procedure for the target MN.

In step 9, the UE may send a RRC message (e.g., RRCReconfiguration ACK) to the target MN.

In step 10 (conditional), the UE may initiate a random access procedure for the target SN.

In step 11, the target MN may send an XnAP message (e.g., SgNB Reconfiguration Complete) to the SN (or target SN). If the UAV configuration is not contained in step 1, the UAV configuration may be added into the XnAP message. At least one of the following information may be contained in the XnAP message: UE identification information (e.g., UE ID), UAV identification information (e.g., UAV ID), UAV subscription information, or UAV configuration containers. The UAV subscription information can include a flag which is used/configured to notify a RAN node that a UE is qualified to use the UAV service. The UAV configuration containers may include LTE configuration container(s) and/or NR configuration container(s).

### Implementation Example 8: From Standalone Architecture to Dual Connectivity Architecture

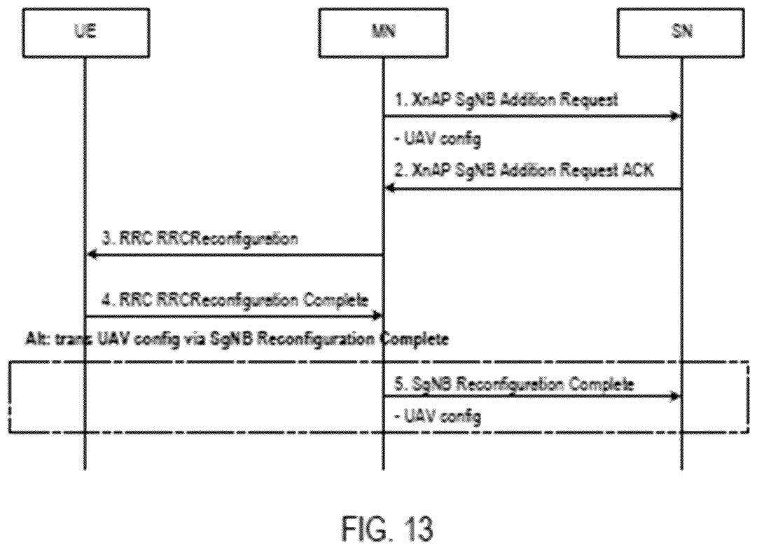

FIG. 13 is a call flow from standalone architecture to dual connectivity architecture procedure. The procedures in the dotted line box are mandatory for this implementation example. The alternative part is which step can be used for UAV configuration transferring. The UAV configuration information can be transferred in either a SgNB addition Request message or a SgNB Reconfiguration Complete message. In some embodiments, it may be impossible for a MN to transfer UAV configuration information to a target SN via both these two XnAP messages.

In step 1, a serving gNB (e.g., MN in the call flow) may decide to add a SN and switch to a dual connectivity (DC). The gNB may send an XnAP message (e.g., SgNB Additional Request) to a SN. At least one of the following UAV configuration information can be contained in the XnAP message: UE identification information (e.g., UE ID), UAV identification information (e.g., UAV ID), UAV subscription information, or UAV configuration containers. The UAV subscription information can include a flag which is used/configured to notify a RAN node that a UE is qualified to use the UAV service. The UAV configuration containers may include LTE configuration container(s) and/or NR configuration container(s).

In step 2, the SN may send a reply XnAP message (e.g., SgNB Addition Request ACK) to the MN.

In steps 3 and 4, the gNB (MN) may send a RRC RRCReconfiguration to a UE, and the UE may reply a RRC RRCReconfiguration Complete to the MN.

In step 5, the MN may send an XnAP message (e.g., SgNB Reconfiguration Complete) to the SN. If the UAV configuration is not contained in step 1, the UAV configuration may be added into the XnAP message. At least one of the following information may be contained in the XnAP message: UE identification information (e.g., UE ID), UAV identification information (e.g., UAV ID), UAV subscription information, or UAV configuration containers. The UAV subscription information can include a flag which is used/configured to notify a RAN node that a UE is qualified to use the UAV service. The UAV configuration containers may include LTE configuration container(s) and/or NR configuration container(s).

### Implementation Example 9: From Dual Connectivity Architecture to Standalone Architecture

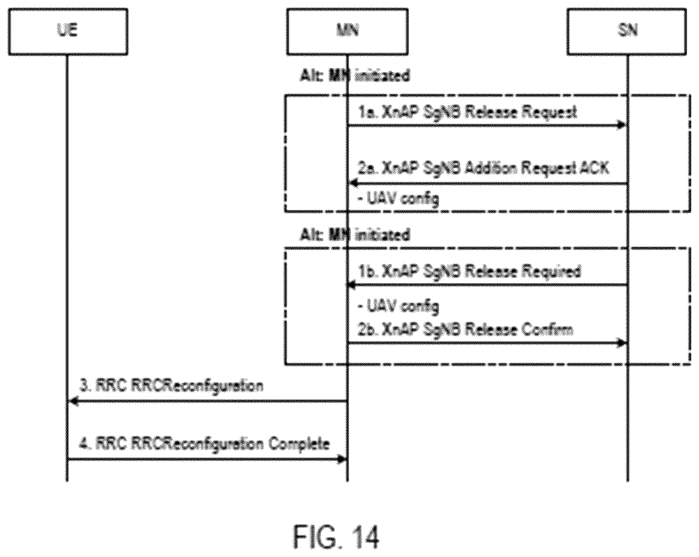

FIG. 14 is a call flow from dual connectivity architecture to standalone connectivity architecture procedure. For a MN initiated SN release, the procedure/step can be 1a=>2a=>3=>4. For a SN initiated SN release, the procedure/step can be 1b=>2b=>3=>4.

### Mn Initiated SN Release

In step 1a, a MN may decide/determine to release a current SN and switch to standalone architecture. The MN may send an XnAP message (e.g., SgNB Release Request) to a SN.

In step 2a, the SN may send an XnAP message (e.g., SgNB Release Request ACK) to the MN. At least one of following information can be contained in the XnAP message: UE identification information (e.g., UE ID), UAV identification information (e.g., UAV ID), UAV subscription information, or UAV configuration containers. The UAV subscription information can include a flag which is used/configured to notify a RAN node that a UE is qualified to use the UAV service. The UAV configuration containers may include LTE configuration container(s) and/or NR configuration container(s).

In steps 3 and 4, the MN may send a RRC RRCReconfiguration to a UE, and the UE may reply a RRC RRCReconfiguration Complete to the MN.

### SN Initiated SN Release

In step 1b, a SN may decide/determine to release itself. The SN may send an XnAP message (e.g., SgNB Release Required) to a MN. At least one of following information can be contained in the XnAP message: UE identification information (e.g., UE ID), UAV identification information (e.g., UAV ID), UAV subscription information, or UAV configuration containers. The UAV subscription information can include a flag which is used/configured to notify a RAN node that a UE is qualified to use the UAV service. The UAV configuration containers may include LTE configuration container(s) and/or NR configuration container(s).

In step 2b, the MN may reply an XnAP message (e.g., SgNB Release Confirm) to the SN.

In steps 3 and 4, the MN may send a RRC RRCReconfiguration to a UE, and the UE may reply a RRC RRCReconfiguration Complete to the MN.

It should be understood that one or more features from the above implementation examples are not exclusive to the specific implementation examples, but can be combined in any manner (e.g., in any priority and/or order, concurrently or otherwise).

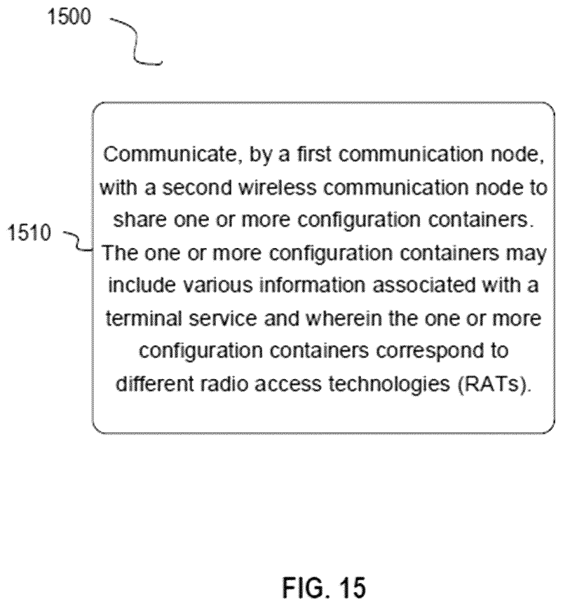

FIG. 15 illustrates a flow diagram of a method 1500 for configuring unmanned aerial vehicle (UAV) multi-RAT dual connectivity (MRDC). The method 1500 may be implemented using any one or more of the components and devices detailed herein in conjunction with FIG. 1-2. In overview, the method 1500 may be performed by a wireless communication node, in some embodiments. Additional, fewer, or different operations may be performed in the method 1500 depending on the embodiment. At least one aspect of the operations is directed to a system, method, apparatus, or a computer-readable medium.

A first wireless communication node (e.g., a master node (MN)) may communicate with a second wireless communication node (e.g., a secondary node (SN)) to share one or more configuration containers. The one or more configuration containers may include various information associated with a terminal service and wherein the one or more configuration containers correspond to different radio access technologies (RATs). The one or more configuration containers may include at least one of a Long-Term Evolution (LTE) configuration container or a New Radio (NR) configuration container.

In some embodiments, the various information may include at least one of: wireless communication device (e.g., Unmanned Aerial Vehicle (UAV)) identification configured to identify a wireless communication device; wireless communication device service subscription information configured to notify the wireless communication node that the wireless communication device is qualified to use wireless communication device service; one or more report receiver's addresses to which wireless communication device's data is to be collected; wireless communication device location information configuring wireless communication device location measurement and reporting; height reporting information associated with the wireless communication device; flight path information associated with the wireless communication device; or measurement information including frequency-related information of the wireless communication device.

In some embodiments, the first wireless communication node may receive a first message including the one or more configuration containers from a core network. The first wireless communication node may send a second message including the one or more configuration containers to a wireless communication device (e.g., a UE). The first message can be a first communication message. The second message can be a second communication message.

In some embodiments, the first wireless communication node may receive a first message including the one or more configuration containers from a core network. The first wireless communication node may send a second message including the one or more configuration containers to the second wireless communication node. The first message can be a first communication message. The second message can be a third communication message. The one or more configuration containers can be further sent to a wireless communication device through a first communication message.

In some embodiments, at least some of the various information can be reported by a wireless communication device to a core network through the first wireless communication node, to the core network through the second wireless communication node, to the core network first through the second wireless communication node then through the first wireless communication node, or to the core network first through the first wireless communication node then through the second wireless communication node.

In some embodiments, the first wireless communication node may send a first message requesting to change the second wireless communication node to the third wireless communication node to a third wireless communication node (e.g., a target node). The first message may include the one or more configuration containers. The first message can be a third communication message.

In some embodiment, the first wireless communication node may receive a first message requesting to change the second wireless communication node to a third wireless communication node from the second wireless communication node. The first wireless communication node may send a second message including the one or more configuration containers to the third wireless communication node. The first message and second message can be each a third communication message.

In some embodiments, the first wireless communication node (e.g., a source MN) may send a first message indicating a handover from the first wireless communication node to the fourth wireless communication node to a fourth wireless communication node (e.g., a target MN). The first message can be an Xn Application Protocol (XnAP) message, and may include the one or more configuration containers. The one or more configuration containers, included in the first message, can be further sent from the fourth wireless communication node to the second wireless communication node through another third communication message.

In some embodiments, the first wireless communication node may send a first message requesting to add the second wireless communication node to the second wireless communication node. The first message can be a third communication message, and may include the one or more configuration containers.

In some embodiments, the first wireless communication node may send a first message requesting to remove the second wireless communication node to the second wireless communication node. The first wireless communication node may receive a second message including the one or more configuration containers from the second wireless communication node. The first message and second message can be each a third communication message.

In some embodiments, the first wireless communication node may receive a first message requesting to remove the second wireless communication node itself from the second wireless communication node. The first message can be a third communication message and may include the one or more configuration containers. In certain embodiments, the first communication message can be an NG Application Protocol (NGAP) message. The second communication message can be a Radio Resource Control (RRC) message. The second communication message can be an Xn Application Protocol (XnAP) message.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A wireless communication method, comprising:
communicating, by a first wireless communication node with a second wireless communication node to share one or more configuration containers,
wherein the one or more configuration containers include various information associated with a terminal service, and wherein the one or more configuration containers correspond to different radio access technologies (RATs).

2. The wireless communication method of claim 1, wherein the one or more configuration containers include at least one of a Long-Term Evolution (LTE) configuration container or a New Radio (NR) configuration container.

3. The wireless communication method of claim 1, wherein the various information includes at least one of:
wireless communication device identification configured to identify a wireless communication device;
wireless communication device service subscription information configured to notify the wireless communication node that the wireless communication device is qualified to use wireless communication device service;
one or more report receiver's addresses to which wireless communication device's data is to be collected;
wireless communication device location information configuring wireless communication device location measurement and reporting;
height reporting information associated with the wireless communication device;
flight path information associated with the wireless communication device; or
measurement information including frequency-related information of the wireless communication device.

4. The wireless communication method of claim 1, further comprising:
receiving, by the first wireless communication node from a core network, a first message including the one or more configuration containers; and
sending, by the first wireless communication node to a wireless communication device, a second message including the one or more configuration containers,
wherein the first message is a first communication message, and the second message is a second communication message.

5. The wireless communication method of claim 1, further comprising:
receiving, by the first wireless communication node from a core network, a first message including the one or more configuration containers; and
sending, by the first wireless communication node to the second wireless communication node, a second message including the one or more configuration containers,
wherein the first message is a first communication message, and the second message is a third communication message.

6. The wireless communication method of claim 5, wherein the one or more configuration containers are further sent to a wireless communication device through a second communication message.

7. The wireless communication method of claim 1, wherein at least some of the various information is reported by a wireless communication device to a core network through the first wireless communication node, to the core network through the second wireless communication node, to the core network first through the second wireless communication node then through the first wireless communication node, or to the core network first through the first wireless communication node then through the second wireless communication node.

8. The wireless communication method of claim 1, further comprising:
sending, by the first wireless communication node to a third wireless communication node, a first message requesting to change the second wireless communication node to the third wireless communication node,
wherein the first message includes the one or more configuration containers, and wherein the first message is a third communication message.

9. The wireless communication method of claim 1, further comprising:
receiving, by the first wireless communication node from the second wireless communication node, a first message requesting to change the second wireless communication node to a third wireless communication node; and
sending, by the first wireless communication node to the third wireless communication node, a second message including the one or more configuration containers,
wherein the first message and second message are each a third communication message.

10. The wireless communication method of claim 1, further comprising:
sending, by the first wireless communication node to a fourth wireless communication node, a first message indicating a handover from the first wireless communication node to the fourth wireless communication node,
wherein the first message is a third communication message, and includes the one or more configuration containers.

11. The wireless communication method of claim 10, wherein the one or more configuration containers, included in the first message, are further sent from the fourth wireless communication node to the second wireless communication node through another third communication message.

12. The wireless communication method of claim 1, further comprising:
sending, by the first wireless communication node to the second wireless communication node, a first message requesting to add the second wireless communication node,
wherein the first message is a third communication message, and includes the one or more configuration containers.

13. The wireless communication method of claim 1, further comprising:
sending, by the first wireless communication node to the second wireless communication node, a first message requesting to remove the second wireless communication node; and
receiving, by the first wireless communication node from the second wireless communication node, a second message including the one or more configuration containers,
wherein the first message and second message are each a third communication message.

14. The wireless communication method of claim 1, further comprising:
receiving, by the first wireless communication node from the second wireless communication node, a first message requesting to remove the second wireless communication node itself,
wherein the first message is a third communication message and includes the one or more configuration containers.

15. A wireless communication method, comprising:
communicating, by a second wireless communication node with a first wireless communication node to share one or more configuration containers,
wherein the one or more configuration containers include various information associated with a terminal service, and wherein the one or more configuration containers correspond to different radio access technologies (RATs).

16. A second wireless communication node, comprising: at least one processor configured to:
communicating, via a transceiver with a first wireless communication node to share one or more configuration containers,
wherein the one or more configuration containers include various information associated with a terminal service, and wherein the one or more configuration containers correspond to different radio access technologies (RATs).

17. A first wireless communication node, comprising: at least one processor configured to:
communicating, via a transceiver with a second wireless communication node to share one or more configuration containers,
wherein the one or more configuration containers include various information associated with a terminal service, and wherein the one or more configuration containers correspond to different radio access technologies (RATs).

18. The first wireless communication node of claim 17, wherein the one or more configuration containers include at least one of a Long-Term Evolution (LTE) configuration container or a New Radio (NR) configuration container.

19. The first wireless communication node of claim 17, wherein the various information includes at least one of:
wireless communication device identification configured to identify a wireless communication device;
wireless communication device service subscription information configured to notify the wireless communication node that the wireless communication device is qualified to use wireless communication device service;
one or more report receiver's addresses to which wireless communication device's data is to be collected;
wireless communication device location information configuring wireless communication device location measurement and reporting;
height reporting information associated with the wireless communication device;
flight path information associated with the wireless communication device; or
measurement information including frequency-related information of the wireless communication device.

20. The first wireless communication node of claim 17, wherein the at least one processor is configured to:
receive, via the transceiver from a core network, a first message including the one or more configuration containers; and
send, via the transceiver to a wireless communication device, a second message including the one or more configuration containers,
wherein the first message is a first communication message, and the second message is a second communication message.
